(19) United States
(12) Patent Application Publication
(10) Pub. No.: US 2016/0098894 A1
(43) Pub. Date: Apr. 7, 2016

(54) INTERMEDIARY PLAY ADJUSTMENT APPARATUS PERFORMING MODIFICATION, EXTENSION, OR ADJUSTMENT OF FUNCTIONALITY IN WAGERING GAMES

(71) Applicant: WMS Gaming Inc., Waukengen, IL (US)

(72) Inventors: SEAN P. KELLY, Skokie, IL (US); MARK B. GAGNER, West Chicago, IL (US); ANURADHA JANDHYALA, Chicago, IL (US); CRAIG J. SYLLA, Round Lake, IL (US)

(21) Appl. No.: 14/503,902

(22) Filed: Oct. 1, 2014

(51) Int. Cl. G07F 17/32

(52) U.S. Cl. CPC G07F 17/3225

(57) ABSTRACT

A gaming system includes an intermediary play adjustment apparatus intercepting original messages from a gaming client process destined for a primary gaming server performing one or more functions related to a primary game. The intermediary play adjustment apparatus analyzes whether the original message impacts one or more secondary features related to the primary game and selectively generates messages by modifying the original message, potentially including one or more modified primary messages for the primary gaming server and one or more secondary messages for one or more secondary gaming servers providing secondary features. The modified primary message may be altered to indicate a wager or parameters different from the wager or parameters specified in the original message. The secondary messages may place additional wagers, report primary game events, or provide primary game specific information to the one or more secondary gaming servers for tracking, gambling, or enhanced content presentation, including play-while away, tournaments, visual presentations, etc.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming apparatus and methods and, more particularly, to an intelligent intermediary gaming system apparatus that bi-directionally communicates with a gaming client machine, a primary wagering game server, and one or more secondary feature servers to intercept, selectively modify, and forward wagering game and secondary feature messages between components of the gaming network.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

Typical prior art systems may be dependent upon a remote server performing the wagering games and using a network client to initiate the wagering game and report results along with associated presentation for the wagering game and the results. It would be beneficial to dynamically perform intelligent gaming functions using legacy wagering game equipment, including both legacy servers and legacy clients, without requiring reprogramming of the legacy equipment. This would enable a wide variety of additional gaming enhancements when interacting with the legacy equipment, for example, tournaments, additional progressive jackpots, integration with current casino services, etc., greatly enhancing gaming options for an end user player.

### SUMMARY OF THE INVENTION

According to one aspect of the present invention, a gaming system comprises an intermediary play adjustment apparatus which bi-directionally communicates with a gaming client, a primary gaming server performing one or more functions related to the primary wagering game, and a secondary feature server. The gaming client performs presentation of a primary wagering game, the primary gaming server performs the primary wagering game itself, and the secondary feature server performs a secondary feature which may be related to or completely independent from the primary wagering game. The intermediary play adjustment apparatus comprises a primary gaming client interface, a primary gaming server interface, a secondary feature server interface, one or more central processing units, and one or more memory devices. The primary gaming client interface couples to the gaming client, the primary gaming server interface couples to the primary gaming server, and the secondary feature server interface couples to the secondary feature server. The one or more memory devices store instructions that, when executed by the one or more central processing units, cause the intermediary play adjustment apparatus to perform a variety of functions and services. Among these functions and services, the intermediary play adjustment apparatus receives, via the primary gaming client interface, the primary gaming server interface, or the secondary feature server interface, an input message, and determines whether the input message corresponds to a game event that impacts the secondary feature, and in response to determining that the input message corresponds to a game event that impacts the secondary feature, the intermediary play adjustment apparatus generates and sends, via the secondary feature server interface, a corresponding second feature message to the secondary feature server. The intermediary play adjustment apparatus also determines whether the input message corresponds to a game event that triggers an action by the primary gaming server, and in response to determining that the input message corresponds to a game event that triggers an action by the primary gaming server, the intermediary play adjustment apparatus generates and sends, via the primary gaming server interface, a corresponding primary gaming message to the primary gaming server. The intermediary play adjustment apparatus determines whether the input message corresponds to a game event that requires display on the gaming client, and in response to determining that the input message corresponds to a game event that requires display on the gaming client, the intermediary play adjustment apparatus generates and sends, via the primary client interface, a corresponding primary display message to the gaming client.

According to another aspect of the present invention, an intermediary play adjustment apparatus bi-directionally communicates with a gaming client, a secondary feature client, a primary gaming server performing one or more functions related to the primary wagering game, and a secondary feature server. The gaming client performs a presentation of a primary wagering game, the secondary feature client performs a presentation of a secondary feature, the primary gaming server performs the primary wagering game, and the secondary feature server performs the secondary feature which may be dependent upon or independent from the primary wagering game. The intermediary play adjustment apparatus comprises a primary gaming client interface, a primary gaming server interface, a secondary feature client interface, a secondary feature server interface, one or more central processing units, and one or more memory devices. The primary gaming client interface couples to the gaming client, the primary gaming server interface couples to the primary gaming server, the secondary feature client interface couples to the secondary feature client, and the secondary feature server interface couples to the secondary feature server. The one or more memory devices store instructions that, when executed by the one or more central processing units, cause the intermediary play adjustment apparatus to perform a variety of functions and services. Among these functions and services, the intermediary play adjustment apparatus receives, via the primary gaming client interface, the primary gaming server interface, or the secondary feature server interface, an input message, and determines whether the input message corresponds to a game event that impacts the secondary feature, and in response to determining that the input message corresponds to a game event that impacts the secondary feature, the intermediary play adjustment apparatus generates and sends, via the secondary feature server interface, a corresponding second feature message to the secondary feature server. The intermediary play adjustment apparatus also determines whether the input message corresponds to a game event that triggers an action by the primary gaming server, and in response to determining that the input message corresponds to a game event that triggers an action by the primary gaming server, the intermediary play adjustment apparatus generates and sends, via the primary gaming server interface, a corresponding primary gaming message to the primary gaming server. The intermediary play adjustment apparatus also determines whether the input message corresponds to a game event that requires display on the secondary feature client, and in response to determining that the input message corresponds to a game event that requires display on the secondary feature client, the intermediary play adjustment apparatus generates and sends, via the secondary feature client interface, a corresponding secondary feature display message to the gaming client.

According to another aspect of the present invention, an intermediary play adjustment apparatus bi-directionally communicates with a gaming client and a feature server. The gaming client performs a presentation of a wagering gaming feature, and the feature server performs one or more functions related to the wagering gaming feature. The intermediary play adjustment apparatus comprises a gaming client interface, a feature server interface, one or more central processing units, and one or more memory devices. The gaming client interface couples to the gaming client and the feature server interface couples to the feature server. The one or more memory devices stores instructions that, when executed by the one or more central processing units, cause the intermediary play adjustment apparatus to perform various functions and services. Among these functions and services, the intermediary play adjustment apparatus receives, via the gaming client interface or the feature server interface, an input message and determines whether the input message corresponds to the wagering gaming feature. In response to the intermediary play adjustment apparatus determining that the input message corresponds to the wagering gaming feature and the input message is received via the gaming client interface, the intermediary play adjustment apparatus generates and sends, via the feature server interface, a modified feature message to the feature server derived from the input message. In response to the intermediary play adjustment apparatus determining that the input message corresponds to the wagering gaming feature and the input message is received via the feature server interface, the intermediary play adjustment apparatus generates and sends, via the gaming client interface, a modified feature response message to the gaming client derived from the input message.

According to yet another aspect of the invention, computer readable storage media is encoded with instructions for directing a gaming system and wagering gaming components utilizing an intermediary play adjustment apparatus to perform the above methods.

According to still another aspect of the invention, the above gaming system having an intermediary play adjustment apparatus is incorporated into a single, free-standing gaming terminal.

According to still another aspect of the invention, the above gaming system having an intermediary play adjustment apparatus is incorporated external to free-standing gaming terminals performing wagering games.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a schematic view of a primary gaming client machine system according to an embodiment of the present invention.

FIG. 3 is a schematic view of an architectural arrangement of a distributed gaming system according to an embodiment of the present invention.

FIG. 4 is a schematic view of an architectural arrangement of a play adjustment apparatus system according to an embodiment of the present invention.

FIG. 5 is a flowchart for an algorithm performed when an intermediary play adjustment apparatus receives an input message according to an embodiment of the present invention.

FIG. 6 is a flowchart for an algorithm performed when an intermediary play adjustment apparatus receives an input message from a primary gaming client process according to an embodiment of the present invention.

FIG. 7 is a flowchart for an algorithm performed when an intermediary play adjustment apparatus receives an input message from a primary gaming server according to an embodiment of the present invention.

FIG. 8 is a flowchart for an algorithm performed when an intermediary play adjustment apparatus receives an input message from a secondary feature server according to an embodiment of the present invention.

FIG. 9 is a flowchart for an algorithm performed when an intermediary play adjustment apparatus receives an input message from a secondary feature client according to an embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino games. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

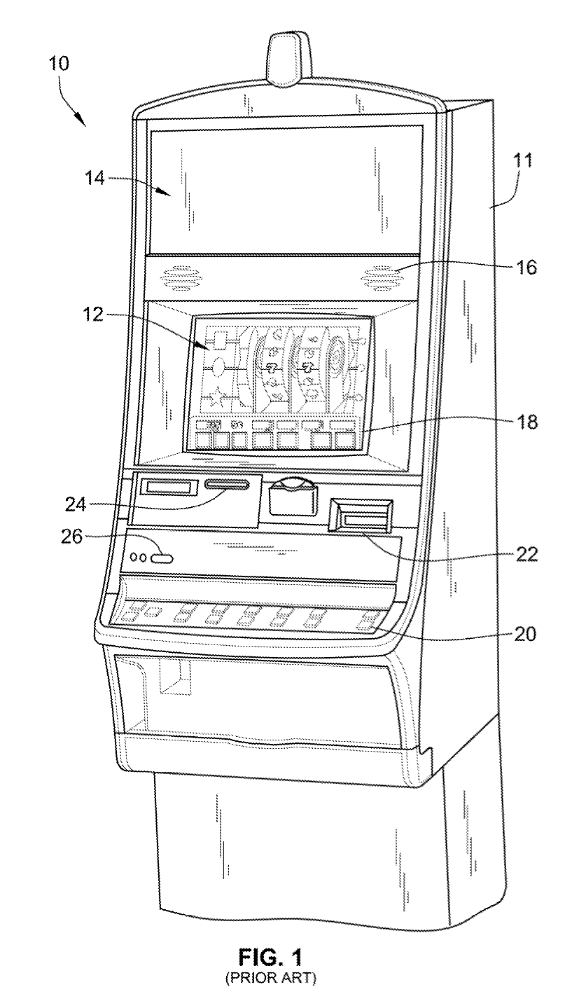

Referring to FIG. 1, there is shown a gaming machine 10 similar to those used in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in conducting wagering games, or may include non-dedicated devices, such as mobile phones, personal digital assistants, personal computers, etc. Exemplary types of gaming machines are disclosed in U.S. Pat. No. 6,517,433, U.S. Pat. No. 8,057,303, and U.S. Pat. No. 8,226,459, which are incorporated herein by reference in their entireties.

The gaming machine 10 illustrated in FIG. 1 comprises a cabinet 11 that may house various input devices, output devices, and input/output devices. By way of example, the gaming machine 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

Input devices, such as the touch screen 18, buttons 20, a mouse, a joystick, a gesture-sensing device, a voice-recognition device, and a virtual-input device, accept player input(s) and transform the player input(s) to electronic data signals indicative of the player input(s), that correspond to an enabled feature for such input(s) at a time of activation (e.g., pressing a “Max Bet” button or soft key to indicate a player's desire to place a maximum wager to play the wagering game). The input(s), once transformed into electronic data signals, are output to a game-logic circuitry for processing. The electronic data signals are selected from a group consisting essentially of an electrical current, an electrical voltage, an electrical charge, an optical signal, an optical element, a magnetic signal, and a magnetic element.

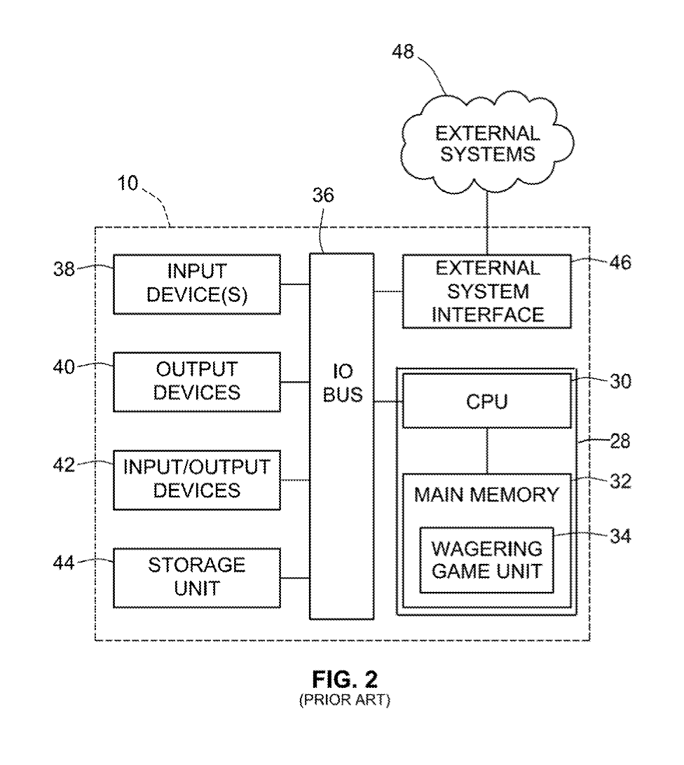

Turning now to FIG. 2, there is shown a block diagram of the gaming-machine architecture. The gaming machine 10 includes game-logic circuitry 28 having a central processing unit (CPU) 30 connected to a main memory 32. The CPU 30 may include any suitable processor(s), such as those made by Intel and AMD. By way of example, the CPU 30 may include a plurality of microprocessors including a master processor, a slave processor, and a secondary or parallel processor. Game-logic circuitry 28, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 28, and more specifically the CPU 30, comprises one or more controllers or processors and such one or more controllers or processors need not be disposed proximal to one another and may be located in different devices or in different locations. The game-logic circuitry 28, and more specifically the main memory 32, comprises one or more memory devices which need not be disposed proximal to one another and may be located in different devices or in different locations. The game-logic circuitry 28 is operable to execute all of the various gaming methods and other processes disclosed herein. The main memory 32 includes a wagering-game unit 34. In one embodiment, the wagering-game unit 34 may cause wagering games to be presented, such as video poker, video black jack, video slots, video lottery, etc., in whole or part.

The game-logic circuitry 28 is also connected to an input/output (I/O) bus 36, which can include any suitable bus technologies, such as an AGTL+ frontside bus and a PCI backside bus. The I/O bus 36 is connected to various input devices 38, output devices 40, and input/output devices 42 such as those discussed above in connection with FIG. 1. The I/O bus 36 is also connected to a storage unit 44 and an external-system interface 46, which may be connected to external system(s) 48 (e.g., wagering-game networks).

The external system 48 includes, in various aspects, a gaming network, other gaming machines or terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external-system interface 46 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 48 such that the gaming machine 10 operates as a thin, thick, or intermediary client. The game-logic circuitry 28—whether located within (“thick client”), external to (“thin client”), or distributed both within and external to (“intermediary client”) the gaming machine 10—is utilized to provide a wagering game on the gaming machine 10. In general, the main memory 32 (comprising one or more memory devices) stores programming for an RNG, game-outcome logic, and game assets (e.g., art, sound, etc.). Alternatively, the RNG may be an additional modular unit which is coupled to, and part of, the game-logic circuitry 28, as part of the gaming machine 10 or an external system 48. When a wagering-game instance is executed, the CPU 30 (comprising one or more processors or controllers) executes the RNG programming to generate one or more pseudo-random numbers. The pseudo-random numbers are utilized by the CPU 30 when executing the game-outcome logic to determine a resultant outcome for that instance of the wagering game. The resultant outcome is then presented to a player of the gaming machine 10 by accessing the associated game assets, required for the resultant outcome, from the main memory 32. The CPU 30 causes the game assets to be presented to the player as outputs from the gaming machine 10 (e.g., audio and video presentations).

The gaming machine 10 may include additional peripheral devices or more than one of each component shown in FIG. 2. Any component of the gaming-machine architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

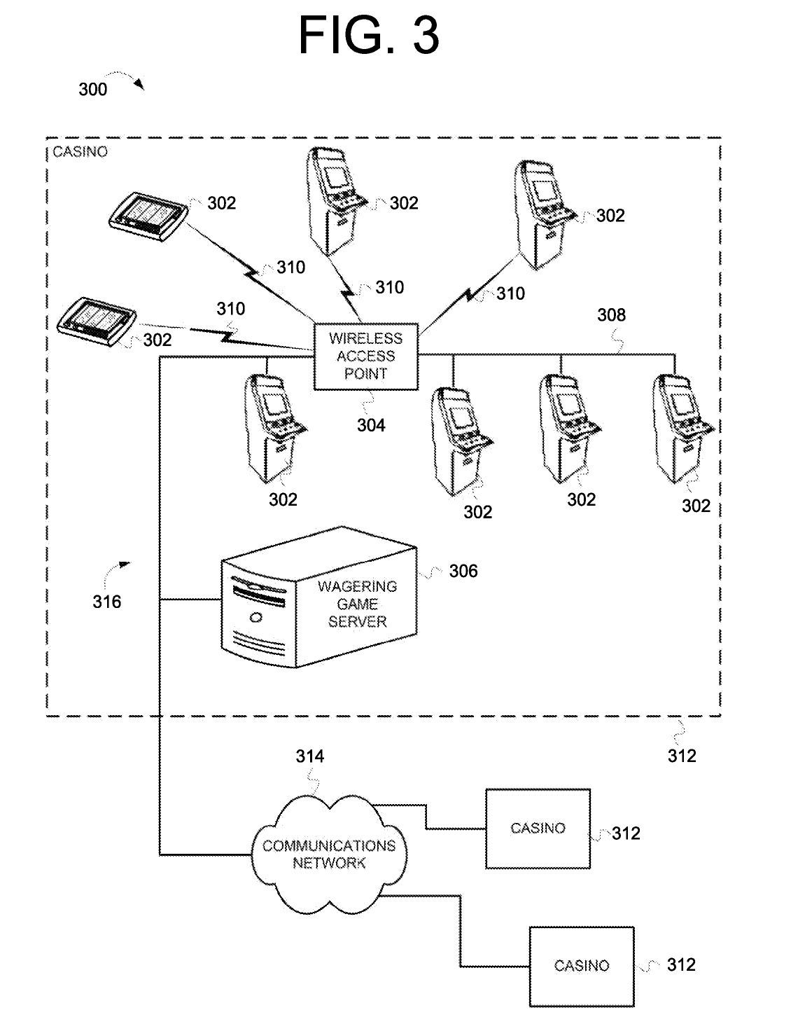

FIG. 3 is a block diagram illustrating a wagering game network 300. As shown in FIG. 3, the wagering game network 300 includes a plurality of casinos 312 connected to a communications network 314. Each casino 312 includes a local area network 316, which includes an access point 304, a wagering game server 306, and wagering game machines 302. The access point 304 provides wireless communication links 310 and wired communication links 308. The wired and wireless communication links can employ any suitable connection technology, such as Bluetooth, 802.11, Ethernet, public switched telephone networks, SONET, etc. In some embodiments, the wagering game server 306 can serve wagering games and distribute content to devices located in other casinos 312 or at other locations on the communications network 314.

The wagering game machines 302 described herein can take any suitable form, such as floor standing models, handheld mobile units, bartop models, workstation-type console models, etc. Further, the wagering game machines 302 can be primarily dedicated for use in conducting wagering games, or can include non-dedicated devices, such as mobile phones, personal digital assistants, personal computers, etc. In one embodiment, the wagering game network 300 can include other network devices, such as accounting servers, wide area progressive servers, player tracking servers, and/or other devices suitable for use in connection with embodiments of the invention.

In some embodiments, wagering game machines 302 and wagering game servers 306 work together such that a wagering game machine 302 can be operated as a thin, thick, or intermediary client. For example, one or more elements of game play may be controlled by the wagering game machine 302 (client) or the wagering game server 306 (server). Game play elements can include executable game code, lookup tables, configuration files, game outcome, audio or visual representations of the game, game assets or the like. In a thin-client example, the wagering game server 306 can perform functions such as determining game outcome or managing assets, while the wagering game machine 302 can present a graphical representation of such outcome or asset modification to the user (e.g., player). In a thick-client example, the wagering game machines 302 can determine game outcomes and communicate the outcomes to the wagering game server 306 for recording or managing a player's account.

In some embodiments, either the wagering game machines 302 (client) or the wagering game server 306 can provide functionality that is not directly related to game play. For example, account transactions and account rules may be managed centrally (e.g., by the wagering game server 306) or locally (e.g., by the wagering game machine 302). Other functionality not directly related to game play may include power management, presentation of advertising, software or firmware updates, system quality or security checks, etc.

Any of the wagering game network components (e.g., the wagering game machines 302) can include specific hardware components and associated machine-readable media including instructions for performing the operations described herein.

In one embodiment, the present invention interjects a play adjustment apparatus performing intelligent gaming functionality between a prior art gaming client and a prior art gaming server. In fact, neither the gaming client nor the gaming server requires any modification to implant the intermediary, functional behavior of the invention, and neither the gaming client nor the gaming server is aware of the presence and function of the play adjustment apparatus. Further, the play adjustment apparatus as described provides a customizable, rich, and highly intelligent intermediary device that can be configured to perform a wide variety of actions that greatly enhances the performance and gaming options for an end user player.

In one embodiment, the present invention bi-directionally intercepts communications that occur between a network gaming client machine and a network gaming server and selectively manipulates the messages passing between the two. This requires that the play adjustment apparatus specifically understand the format (protocol) and consequence (effect, intent) of the messages being sent and received from network gaming clients and network gaming servers. In response, the play adjustment apparatus can selectively modify the traversing messages to influence or impact any aspect of the gaming server configuration and gaming initiation or outcome.

As a general rule, the play adjustment apparatus is placed logically (and typically connectively physically) between a primary wagering gaming client, a primary wagering gaming server, and one or more secondary gaming servers. The primary wagering gaming server is generally configured to perform one or more functions related to a primary wagering game, including performing the primary wagering game itself, although this is not always the case. The primary wagering gaming server may perform any function directly associated with the primary wagering game, for example, providing presentation information including video or themed presentation output for the primary wagering game, provision of game accounting, game state recording, random number generation, and/or configuration data for a gaming machine.

Additionally, the one or more secondary servers are communicatively coupled to the play adjustment apparatus. The one or more secondary servers may include feature servers which provide the specifics of any additional features that the secondary servers provide to enhance, alter, or otherwise benefit a wagering game operating on the primary wagering game client and server. For example, the secondary server may be one or more of a progressive controller managing local or distributed progressive jackpots, a tournament management controller managing local or distributed tournaments of wagering game play, or a promotional event controller managing the alteration of wagering games in accordance with a promotional event or sponsor and associated monetary account.

The wagering game client may additionally be an established legacy system component, developed well before the development and implementation of the play adjustment apparatus. Indeed, there are numerous embodiments where the operations of the play adjustment apparatus are completely inconspicuous and invisible to the wagering gaming client and server combination; however, the reverse is not the case. The play adjustment apparatus is configured to recognize, analyze, and modify the format and intent of messages flowing between the wagering gaming client and server. This enables the play adjustment apparatus to operate dynamically during communication and selectively alter the communications between the gaming client and server. This may include providing one or more secondary features enhancing or altering the wagering game. The play adjustment apparatus may also provide additional functional features based on the wager and/or result of the wagering game, as well as the selective presentation of content on the legacy hardware.

The client-server gaming architecture housing the play adjustment apparatus also includes an additional piece of play adjustment hardware, optionally appended to the original client interface. The positioning of the play adjustment hardware may be remote from or directly coupled to the intermediary play adjustment apparatus, and may be positioned at the wagering gaming client and/or server. The use of one or more intermediary modules in this way provide the ability for the play adjustment apparatus to modify the player-perceived behavior of the wagering game of the base client machine without requiring any modification of one or both of the original client and the original server hardware and software.

In one embodiment, a wagering game client may comprise any amount of non-evaluating interface logic by which a user may specify a wager and observe an outcome. The wagering game server may comprise any amount of evaluating game logic that receives input from the client and reports a subsequent outcome to the wagering game client. It is possible (but not necessary) that the client and server be on separate physical devices, or created as separate and independent software units performed on generalized or specialized hardware, remote or local to each other. Further system details may include game clients that communicate with servers over a local-area or wide-area network, or to a player-user interface (PUI) system where touch-input and button-input to a wagering game is intercepted and potentially modified prior to being sent to the wagering game; the wagering game display input and output is intercepted by the PUI and selectively modified before being presented to the player.

Programmatic instructions to control the operation of the play adjustment apparatus hardware may be provided using hard-wired, non-programmable mediums (e.g., firmware or read-only memory) or be instituted using stored or retrieved functional instructions (e.g., via the communications network or provided from volatile or non-volatile random access memory, Electrically Erasable Programmable Read-Only Memory (EEPROM), etc.). The play adjustment apparatus may be implemented in a single intermediary device, or be distributed into multiple components which are selectively and intentionally placed in the network based architecture to provide the described functionality. Any of these embodiments are within the spirit and scope of the invention as disclosed. In any instance, the play adjustment apparatus as disclosed requires communication means to transfer information between system components. This includes physical interfaces, in addition to any logical designations that accompany a given physical interface.

Secondary features may include any application that can use or alter wagering game input and response messages to provide additional features or enhancements to the base wagering game(s). For example, the play adjustment apparatus makes it possible to conduct tournaments for players of legacy video slot machines (in addition to any other type of network wagering game client) by tracking any number of different variables (e.g., games played, cash in, winning spins, credits won, credits played, highest payout, etc.). In one embodiment, the play adjustment apparatus is configured to map base game win amounts to tournament points, e.g. award a number of points over a fixed number of spins within a given time period. The play adjustment apparatus may provide tournament management for any base game without the base game knowing any details of how the bets are modified. Each tournament can be further configured to have specific requirements/rules, include any combination of selective legacy machines, and run during specific times. Indeed, the play adjustment apparatus is further capable to perform tournaments of tournaments, for example, tracking and ranking multiple participants among multiple (potentially simultaneous) tournaments and award participants according to the overall placement in any subset of the ranked tournaments. Any slot game may be used as a base game for a tournament without any alteration of the base game itself.

The play adjustment apparatus is also configured to perform a play-while-away (PWA) function, where the play adjustment apparatus automatically intercepts a wagering message from the client and subsequently places one or more wagers on the player's behalf to a specified wagering base game server, often while the original client or player is disconnected or becomes idle. Alternatively, the play adjustment apparatus may offload the functional process of the PWA process to a secondary feature server that issues the PWA wager requests to a primary gaming server or another secondary feature server via the play adjustment apparatus. Various parameters may be stipulated for such PWA requests, including credit or wager commitment, time start/stop/delay and wager placement spanning, specific wagering game(s) for some or all wagers, etc. Depending upon the implementation, the play adjustment apparatus will collate the responses for presentation to the player individually (or alternatively as a combined set of results), or offload this collating functionality to a suitable secondary feature server and act as an intermediary to the client(s) and server(s). In any event, the final collated information will be processed by the play adjustment apparatus on the way to client display as any other input message.

The play adjustment apparatus is also configured to perform various promotional activities that enable the play adjustment apparatus to access one or more remote promotional event servers which provide notifications, monetary accounts, secondary wagering games, secondary features, entertainment, etc. One embodiment includes a base wagering game system having details of wagering game play intercepted by the play adjustment apparatus and selectively registered with the promotional event server which broadcasts event details or modified/additional promotional outcomes via the original client interface or a secondary play adjustment user interface. For example, a special launch promotion may be constructed where committed marketing funds are used to guarantee all wins on a new or given theme and/or boost winning results using specific themes $0.50 higher than normal.

As stated above, the play adjustment apparatus is generally installed between a network server and client, physically and logically positioned in the communication link to mediate all traffic between the two. The client process may be additionally “wrapped” in an additional process (e.g., a combined secondary feature client user interface and communication interface, sometimes collectively referred to as the player adjustment interface) providing outbound messages which pass through the play adjustment apparatus which recognizes participation in a secondary feature event (e.g., a tournament). In many embodiments, the play adjustment apparatus intercepts messages between server and client, reformulating and/or rerouting the messages to one or more secondary feature servers. For example, a secondary feature server system may be used to recognize initialization messages of the wagering game and cause the play adjustment apparatus to modify the message by intercepting and converting the initialization message to be compatible with a lower pay table game server (or a lower pay table game on the same server), redirect the message to a (secondary feature) version of the original wagering game server configured at the new percentage, and process the response(s) and forward outcome results to the secondary feature tournament system server for point calculation and partitioning off a small portion of the wager/payout amount to adjust for the tournament percentage and fund the tournament, and send a suitably modified response to the wagering game client as if an unaltered transaction with the original game server is occurring. That is, the play adjustment apparatus is configured to manipulate messages and communication to provide essentially any “secondary feature or experience” developed “after the fact” to any base wagering or non-wagering game.

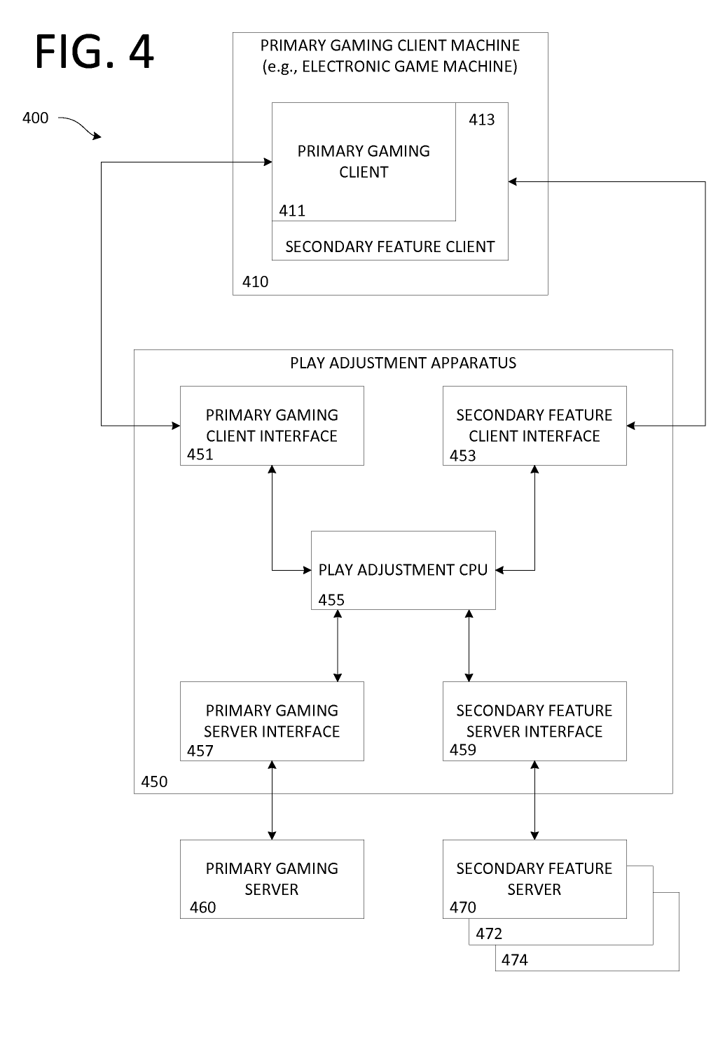

Referring to FIG. 4, one embodiment of the play adjustment apparatus system 400 is shown as a generalized architectural arrangement. The play adjustment apparatus system 400 includes a primary gaming client machine 410, an intermediary play adjustment apparatus 450, and a primary gaming server 460. The play adjustment apparatus 450 includes a primary gaming client interface 451 that connects to a primary gaming client process 411 running on the primary gaming client machine 410, and a secondary feature client interface 453 that connects to a secondary feature client process 413 running on the primary gaming client machine 410. One or both of the primary gaming client interface 451 and the secondary feature client interface 453 may be active during communication between the primary gaming client machine 410 and the primary gaming server 460.

In one embodiment, it is possible for the primary gaming client process 411 and the secondary feature client process 413 to be executing on different physical devices, for example, by using a remote or community display, mobile device, etc. (not shown). This embodiment may further include an enhanced communicative structure not specifically pictured enabling additional messages to pass between these devices. Generally, the secondary feature client process 413 “encapsulates”, “contains”, or is “wrapped around” the primary gaming client process 411 on the primary gaming client machine 410, as is known in the art.

In one embodiment, the secondary feature client process 413 may be embodied through a scripted hypertext markup language (HTML) web page interpreted on (or between) the primary gaming client machine 410 and the play adjustment apparatus 450, or some other programmatic process logically “wrapped around” the base wagering game process primary gaming client 411 or intermediary as a part of the secondary feature client interface 453 prior to sending information for display. In this embodiment, the secondary feature client process 413 generally acts as a conduit for information flow from the play adjustment apparatus 450 to the primary gaming client 411 via the secondary feature client interface 453, but the primary gaming client 411 may directly interface with the play adjustment apparatus 450 via the primary gaming client interface 451, additionally or alternatively. In another embodiment, a secondary physical or functional software module, either separately coupled or integrated within one or more of the primary gaming client machine 410 and the play adjustment apparatus 450, includes a player-user interface (PUI) module acting as an extension of the primary gaming client machine 410 and/or the primary gaming client 411. This embodiment may additionally include the inclusion of a physical PUI module or functional software component as part of a completely distinct device, such as a mobile device or a community display device having a configured application (e.g. “app”) or physical module to impart such functionality. For example, this may include a secondary display/device to provide gameplay and standings (e.g., for tournaments) of active secondary features that do not alter the display of the primary wagering game or the primary gaming client interface in any way.

The primary gaming server 460 is generally configured to perform one or more functions related to the primary wagering game, which may include generation a random outcome for the primary wagering game itself, perform accounting for the primary wagering game, generate video output for the primary wagering game, or essentially any other function that may relate to the execution, performance, and operational requirements of the primary wagering game.

The play adjustment apparatus 450 also includes a primary gaming server interface 457 that connects to a suitable interface of the primary gaming server 460, and secondary feature server interface 459 that connects to a suitable interface of a secondary feature server 470. In the event there are multiple secondary feature servers (e.g., 470, 472, 474), a corresponding secondary feature server interface 459 will be instantiated for each of the secondary feature servers being communicated with.

Each of the primary gaming client interface 451, the secondary feature client interface 453, the primary gaming server interface 457, and the secondary feature server interface 459, connect to and communicate with the play adjustment apparatus central processing unit (CPU) 455. The play adjustment apparatus CPU 455 is the programmed component that analyzes the communication flowing between the system clients and servers, and operates to modify and create messages, as needed, to enable secondary features available to the player of the primary gaming client machine 410 during interaction with the primary gaming client process 411 and the secondary feature client process 413.

Likewise, in other embodiments, the play adjustment apparatus 450 may be a part of the above mentioned PUI, running on or coupled to the same processor of the primary gaming machine 410 as an encapsulating interface (generated from code in the system, remotely downloaded/retrieved, or retrieved from firmware, etc.), or coupled to one or more of the primary gaming server 460 and one or more secondary feature servers 470, 472, 474. Similarly, the play adjustment apparatus 450 may be envisioned completely independently from, or wholly or partially integrated with practically any system component, while directly or indirectly coupled to the same, providing physical and logical intermediary placement and communication ability is suitably maintained.

In one embodiment, the play adjustment apparatus 450 operates as a passive (pure) proxy by simply forwarding messages between the primary gaming client 411 and the primary gaming server 460 to provide a completely unaltered base game experience. However, alternatively, the play adjustment apparatus 450 is highly intelligent, providing a widely variable and customizable interactive and intermediary role for communications between all the networking elements, unlike a simple passive proxy. In another embodiment, the play adjustment apparatus 450 implements sets of complex rules or specified conditions causing new or modified messages to be selectively generated and directed to the one or more secondary feature servers 470, 472, 474. As stated prior, secondary feature servers 470, 472, 474 may be configured to perform various forms of extended gameplay or other added secondary features. This may include enhancing operation of a base primary gaming client 411 after the primary gaming client machine 410 is deployed, for example to a casino floor, in addition to (or in replacement of) sending the primary wagering game message(s) to the primary gaming server 460. The play adjustment apparatus 450 actively monitors, modifies, and manipulates data content and messages for any and all communication between the primary gaming client machine 410 and the primary gaming server 460, in addition to generating entirely new messages for talking to other secondary systems (including secondary feature servers 470, 472, 474), if required.

While the base primary wagering game does not know about the play adjustment apparatus 450, the play adjustment apparatus 450 must know about the specific game(s) in which it interacts. This potentially includes details of client and server, communicative and message content protocol definitions, development arrangement, configurations, etc. The protocol for communication and message exchange between a primary base game client 411 and a primary game server 460 are generally proprietary, and when known, may be leveraged by the play adjustment apparatus 450 to analyze and suitably modify messages flowing back and forth between the endpoints. Further, the play adjustment apparatus 450 may also operate between a primary gaming server 460 and a plurality of secondary feature servers 470, 472, 474 to facilitate messaging between servers for purposes of information exchange, game initiation, secondary features, etc. The present invention leverages knowledge about the communication interfaces of the clients and servers to flexibly provide varying types of behavior, including modification of functional behavior and programmatic content of the various components from a physically and logically intermediary position on the network.

In one embodiment, the play adjustment apparatus 450 “fractures” or splits game initiation messages specifying an initial client wager from a primary client process 411 into multiple portions (i.e., plural messages) that are forwarded to a set of respective secondary feature system server(s) 470, 472, 474 for gaming determinations and resulting pay tables and payouts for multiple games, including the “original” primary gaming server 460 to which the client message would be delivered if the play adjustment apparatus 450 was not present. These modified messages may include messages generated by modifying the original message sent by the primary gaming client 411 to the primary gaming server 460.

When messages are received by the play adjustment apparatus 450, the messages are analyzed to determine what type of processing should be performed in accordance with the request and any secondary features that may be affiliated with the primary wagering gameplay. It is possible for received messages to be received in a self-contained package requiring no further additional information for processing, as well as multiple messages relating to the same transaction being required. As a general rule, the play adjustment apparatus 450 will wait until all (or sufficient) information has been received to begin processing the received information to generate one or more outgoing messages directed to one or more of the primary gaming client machine 410, primary gaming server 460, and/or secondary feature servers 470, 472, 474.

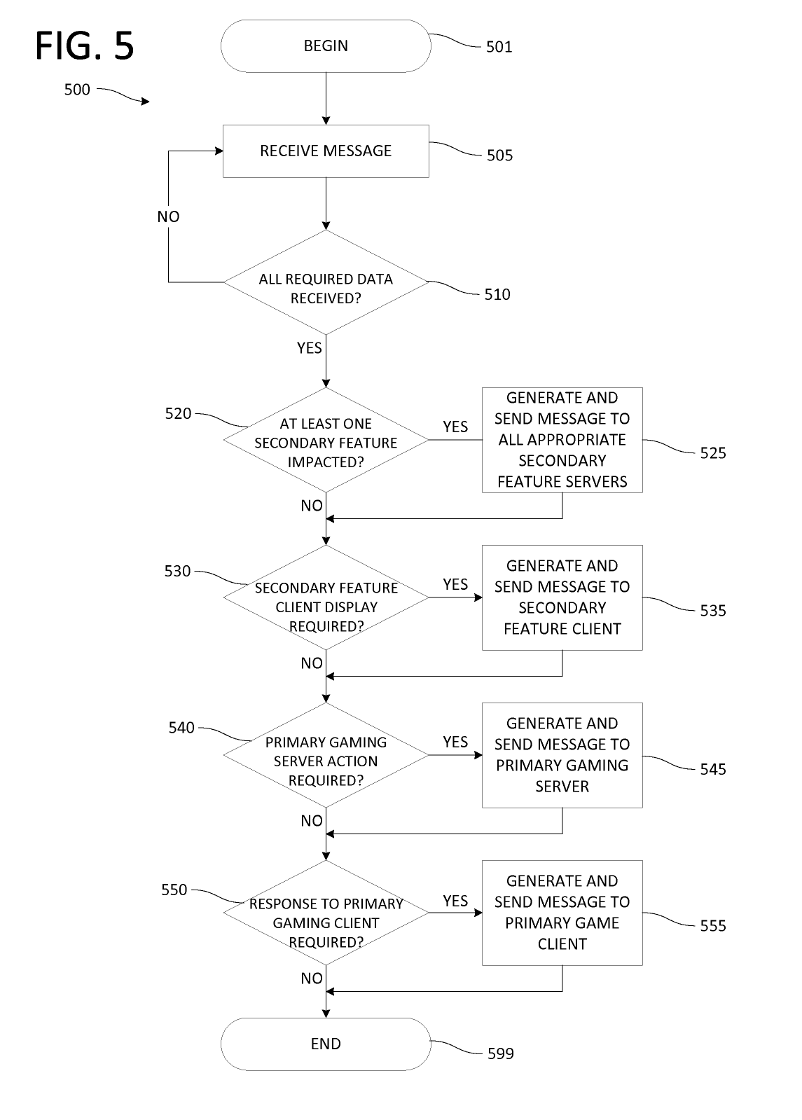

Referring to FIG. 5, an algorithmic process 500 is described which is performed when play adjustment apparatus 450 receives an input message at one of its interfaces according to one embodiment. Process 500 begins with the initiation of the message reception process 501. This may include the initialization of the play adjustment apparatus 450, verification of the coupled machinery and components to one or more of the interfaces of the play adjustment apparatus 450, and activation of one or more secondary features in accordance with the operation of the primary gaming client 410.

In step 505, a message is received at one (or more) of the interfaces of the play adjustment apparatus 450.

In step 510, a determination is made as to whether all the data that relates to a given operation specified in the message which has been received (or alternatively, all required messages or information containing relevant data to a given operation) is present within the play adjustment apparatus 450, i.e., has been received. If not, further message(s) may have to be received (flow returns to step 505) prior to processing the message information that has been already received. There are a wide variety of examples that may include data reception requiring multiple messages, including the involvement of multiple secondary feature servers 470, 472, 474 in determining a secondary feature outcome, or the retrieval of portions of a pay table from a data repository of a primary wagering server 460. For example, it is possible that plural messaging is required to derive or determine all the information required to process a given received input message. That is, an input message may require a very complex, parallel messaging process to completely determine the outcome, response, or determination for the input message and the information within. In the event that multiple messages are required, the play adjustment apparatus 450 will perform reception (and/or sending) of all such required messaging prior to moving onto the next phase of the operation. This parallel messaging may include one or more sub-processes involving sending, receiving, and processing of preliminary messages. The preliminary messages may be generated or received in response to requests made prior to the current operation completion and may be dependent upon further generation of outgoing messages related to the original input message.

The play adjustment apparatus 450 is intelligently equipped to determine sets of operations which must be performed prior to the initiation of subsequent operations. In this way, it is possible for the play adjustment apparatus 450 to complete complex operations involving multiple primary gaming servers 460, multiple secondary feature gaming servers 470, 472, 474, and a multitude of primary gaming client machines 410, to implement a wide variety of secondary features as desired. In one example, upon receiving an input message indicating a wager from the primary gaming client 411, the play adjustment apparatus 450 may be required to proactively query or await secondary-feature-configuration information from a secondary server 470 before constructing the appropriate message(s) to the primary gaming server 460.

In step 520, after all the required information is received for the processing of the message(s), a determination is made as to whether the message information (for example, game event(s) contained or described within the message information) impacts at least one secondary feature that is currently active.

In step 525, when it is determined that at least one secondary feature is impacted, individual messages are generated and sent to the secondary feature servers 470, 472, 474 that are related to the impacted secondary features. For example, if the play adjustment apparatus 450 is coordinating a distributed slot machine tournament based on wager amount and winning percentage, a message is generated and sent indicating the amount being wagered for every wagering game to a secondary feature server handling this aspect of tracking the tournament activity. Additionally, another message may be generated and sent specifying the winning results for each wagering game to another secondary feature server 470, 472, 474 during reception of a primary game result message in order to completely track the tournament specifics and relevant activity. Any number of secondary feature servers 470, 472, 474 may be specified during this processing, depending upon the specifics of the secondary features being performed. Further, secondary feature response message(s) from secondary feature servers (e.g., server 470) may cause the generation and sending of additional secondary feature messages to other secondary feature servers 470, 472, 474 performing secondary features that are dependent upon the results of other secondary features. For example, a “tournament of tournaments” may be performed that tracks a number of points for a number of players gaining points by winning or placing in various tournaments. In this instance, the result(s) of one or more tournaments may cause the reporting of secondary feature results to another secondary (i.e., tertiary) feature server 474 tracking such information. In short, any messages received by the play adjustment apparatus 450 that are judged to contain information impacting one or more secondary features will result in a generated message specific to the information being reported and resultantly sent to an appropriate second feature server for processing.

In step 530, after any impacts to the secondary features have been resolved, a determination is made as to whether the input message(s) require any resultant or consequential presentation of information or imagery on the secondary feature client 413.

In step 535, if presentation on the secondary feature client 413 display is determined to be required, one or more suitable messages are generated and sent to the secondary feature client 413 to cause such information display.

In step 540, after any appropriate secondary feature client 413 display messages are generated and sent (and assumedly performed by the secondary feature client 413, wherein a confirmation may be required to ensure this), a determination is made as to whether the input message requires any action or participation of the primary server 460. This may include performing the primary wagering game on which one or more secondary features determinations are or will be subsequently based upon, or alternatively, tracking actions, accounting, monitoring, etc., the primary wagering game performed on the client machine 410 itself or another gaming server. This may further include the generation of a random number via a RNG, a determination of a resultant outcome, and/or specified condition for additional operations like a bonus game or additional spins of the primary wagering game. Alternatively, the primary server 460 may be performing accounting or state maintenance for the primary gaming client 411 or the client machine 410 as a whole. The result of a wagering game server 460 and associated wagering game is highly variable, and is generally a result of design choice for primary wagering game implementation; because the play adjustment apparatus 450 is configured to intercept, interpret, and generate formatted messages passing between a primary gaming client 411 and a primary gaming server 460, the play adjustment apparatus 450 is fully capable of providing a wide variety of functional options that can directly modify the primary wagering game configuration and parameters performed by the primary gaming server 460 by altering or generating messages specifically for this purpose.

In step 545, when action or participation of the primary server 460 is required, an appropriate message is generated and sent to the primary server 460 to conduct the primary wagering game. In some instances, this generated message is fully distinct and different from the initial input message received by the play adjustment apparatus 450. For example, if the play adjustment apparatus 450 is currently configured to perform secondary features that are funded by a portion of the primary game wager as indicated in the input message, the generated primary gaming server message will specify a different wager amount than the wager amount specified in the input message. Alternatively, in a play-while-away embodiment of the play adjustment apparatus 450, a portion of the wager specified in the input message may be specified in each of the resulting primary gaming server messages that are generated. In yet another embodiment, the generated message may be an alternative configuration/initialization message generated to configure the primary wagering game server 460 (e.g., the primary wagering game) in a specified, modified way that differs from the parameters specified in the input message initially received by the play adjustment apparatus 450.

In step 550, after any appropriate messages are generated and sent to the primary gaming server 460 (and potentially, a response received and processed), a determination is made regarding the necessity to generate and send a message to the primary gaming client 411. The generation of this message is typically a result of any response message being sent, via the play adjustment apparatus 450, to the primary gaming client machine 410 from the primary gaming server 460. Messages of this type include, but are not limited to, a response to a configuration request, the result of a primary wagering game executing on primary gaming server 460, or an informational display dictation made on behalf of a primary wagering server 460. Effectively, any message containing information for primary gaming client 411 display received by play adjustment apparatus 450 may be interpreted, processed, and potentially reformatted to modify any resultant output on the primary gaming client 411.

In step 555, any messages that are required for the primary gaming client 411 are generated and sent to the primary gaming client 411 via the primary gaming interface 451. Naturally, the interpretation and presentation of the information included therein is reserved for the primary gaming client 411 once received. This directly infers that the message will be “native to”, compatible, and fully understood by the primary gaming client 411.

Once the detailed steps above are performed and completed, process 500 ends with step 599 upon termination.

In one embodiment, when an input message is received by the play adjustment apparatus 450 from a primary gaming client 411, a subset of the above detailed process is specifically performed in response to the reception of the input message.

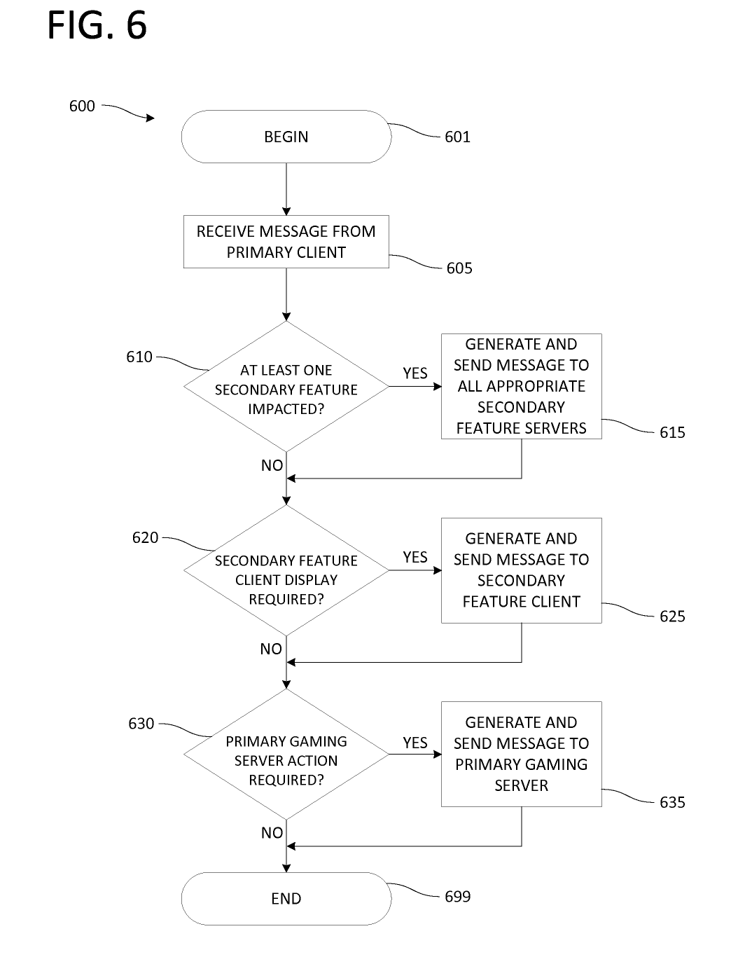

Referring to FIG. 6, an algorithmic process 600 is described which is performed when play adjustment apparatus 450 receives an input message from a primary gaming client 411 via the primary gaming client interface 451, according to one embodiment. Process 600 begins with the initiation of the message reception process 601. This may be performed, for example, when the primary gaming client interface 451 is established or when the primary gaming client 411 is initialized.

In step 605, a message is received at the primary gaming client interface 451 from the primary gaming client 411. Messages received at the primary gaming client interface 451 from the primary gaming client 411 may include global game initialization messages (requests for retrieval of programmatic code, pay table(s), skins, primary wagering game specifics, etc.), game initiation messages (player identification, pay table in use, player account, etc.), and game play transaction messages (start spin, quick stop spin, engage bonus feature, place side bet, player selections, etc.), requesting communication with primary gaming server 460, among others. The message received at the primary gaming client interface 451 from the primary gaming client 411 is typically an unaltered base (legacy) game message generated by the primary gaming client 411.

In step 610, a determination is made as to whether the message information (for example, a game event described within the message information) impacts at least one secondary feature that is currently active. As stated prior, a primary video slot game initiation message specifying a particular wagering game, corresponding wager amount, selected pay lines, player identification, etc., may be received in response to a player activating the initiation of the primary wagering game at the primary gaming client machine 410. This message is intercepted en route to the primary gaming server 460 and a determination is made as to whether the message indicates one or more game events or information within that will impact an active secondary feature as managed by one or more secondary feature servers 470, 472, 474.

In step 615, when it is determined that at least one secondary feature is impacted by the input message, individual messages are generated and sent to the secondary feature server(s) 470, 472, 474 that are related to the impacted secondary features. For example, if the play adjustment apparatus 450 is helping coordinate a distributed slot machine tournament based on wager amount and winning percentage, a message is now generated and sent to a secondary feature server (for example, server 470) indicating the amount being wagered for the current wagering game. Any accounting of wagering game winning percentages is inherently a part of a wagering game result (derived from a corresponding wagering game result message) and must be separately tracked when the play adjustment apparatus 450 receives a message containing wagering game result information from the primary gaming server 460. Any number of secondary features and secondary feature servers 470, 472, 474 may be specified in response to the primary game message, as long as a corresponding secondary feature is initialized and one or more secondary feature servers 470, 472, 474 are configured to receive such messages from the play adjustment apparatus 450. The result of the messages generated and sent to secondary feature servers 470, 472, 474 may include any combination of splitting wagers, initiating or playing new secondary features, substituting, removing, or otherwise modifying message data specific for a given secondary feature, etc.

In step 620, after any generation and transmission of messages that impact secondary features, a determination is made as to whether the received primary gaming message requires any resultant or consequential presentation of information or imagery on the secondary feature client 413. For example, if a distributed slot tournament is in progress, an updated total of points for the tournament may be desired for display to the client. A corresponding message delivered to the secondary feature client 413 is required for this information exchange to occur. Alternatively, information may be additionally provided for a community display on another gaming/presentation client, performing a separate secondary feature client process, delivered via another secondary feature client interface. Likewise, a secondary feature may include presentation information, for example, animation that is related to the primary game being concurrently performed. The details of the secondary feature and/or any included information for the display of such a secondary feature must be generated and sent to the secondary feature client 413 for subsequent rendering.

In step 625, if presentation on the secondary feature client 413 display is determined to be required, one or more suitable messages are generated and sent to the secondary feature client 413 via the secondary feature client interface 453 to deliver appropriate information and cause such information display. As detailed above, a plurality of secondary feature clients may be present, each requiring a message sent via a corresponding client interface. The play adjustment apparatus 450 performs the appropriate message generation and transmission at this stage.

In step 630, after any appropriate display messages are generated and sent to the secondary feature client 413, a determination is made as to whether the received primary gaming message requires any action or participation of the primary server 460.

In step 635, when action or participation of the primary server 460 is determined to be required, an appropriate message is generated and sent to the primary server 460 to conduct the primary wagering game, configure the primary wagering game, etc. In some instances, this generated message is fully distinct and different from the initial input message received by the play adjustment apparatus 450. For example, if the play adjustment apparatus 450 is currently configured to perform secondary features that are funded by a portion of the primary game wager as indicated in the input message, the generated primary gaming server message will specify a different wager amount. Alternatively, in a play-while-away embodiment of the play adjustment apparatus 450, a portion of the wager specified in the input message may be specified in each of the resulting primary gaming server messages that are generated. The generation of plural messages, timing, and divided wager information may also be passed to or actively controlled and determined by a secondary feature server operating to fulfill the play-while-away process. In yet another embodiment, the generated message may be an alternative configuration/initialization message generated to configure the primary wagering game server 460 (e.g., the primary wagering game) in a specified, modified way that differs from the parameters specified in the input message initially received by the play adjustment apparatus 450. In an embodiment where the primary wagering game is simply being tracked (for example, wager amount and winning percentages, used prior), the message sent to the primary gaming server 460 may be simply forwarded in the same form as received.

Typically, when a secondary feature is invoked that alters the input message received by the primary gaming client 411, the modified primary gaming server message is sent to the primary gaming server 460 to perform the modified primary game using the altered conditions and parameters. Alternatively, an alternate instance of the primary gaming server 460 may be initiated and configured in accordance with the alterations (for example, having a different pay table) or a completely new server that emulates the primary gaming server 460 may be created having the requires parameters.

Once received, the primary gaming server 460 will respond to the message in a predictable way, for example, by performing the primary wagering game specified by the message with the provided parameters.

Once the detailed steps above are performed and completed, process 600 ends with step 699 upon termination.

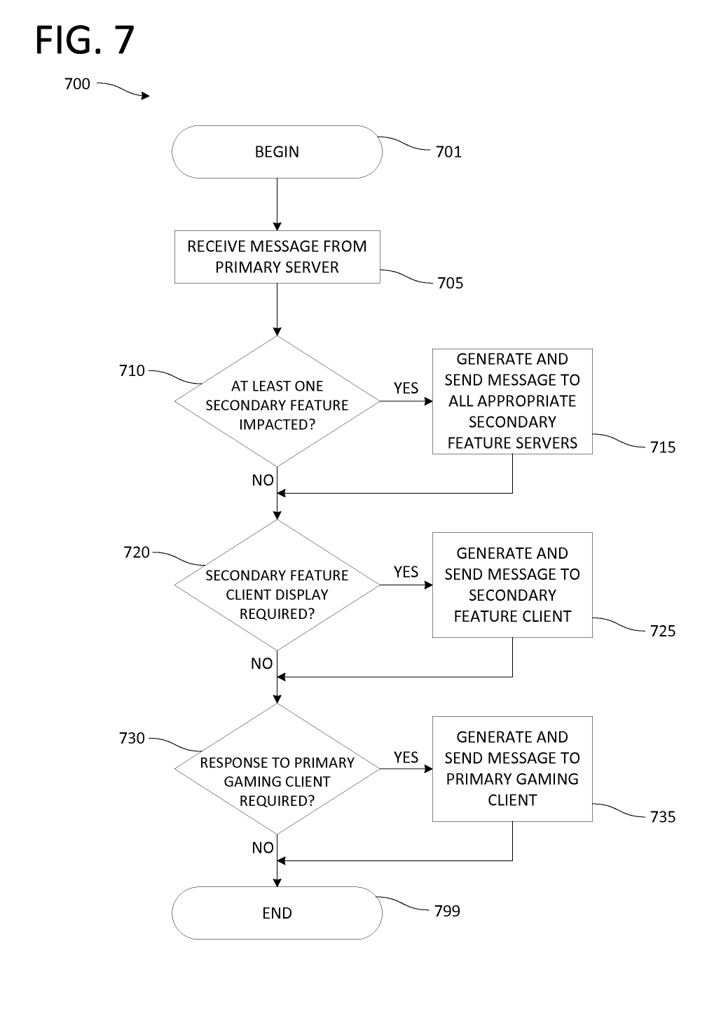

Referring to FIG. 7, an algorithmic process 700 is described which is performed when play adjustment apparatus 450 receives an input message from a primary gaming server 460 via the primary gaming server interface 457 according to one embodiment. Process 700 begins with the initiation of the message reception process 701. This may be performed, for example, when the primary gaming server interface 457 is established, when the primary gaming server 460 is initialized, or in response to a primary wagering game message received from the primary gaming client 411 to initiate a primary wagering game.

In step 705, a message is received at the primary gaming client interface 457 from the primary gaming server 460.

In step 710, a determination is made as to whether the message information (for example, a wagering game result or other game event described within the message information) impacts at least one secondary feature that is currently active. In one embodiment, a primary video slot game result message specifying a result for a particular wagering game, including payout amount, winning pay lines, etc., may be received as a result of the primary gaming server 460 processing a player initiated primary wagering game message generated at the primary gaming client machine 410. This response message is intercepted en route from the primary gaming server 460 to the primary gaming client 411 and a determination is made as to whether the message indicates one or more game events or states that impact an active secondary feature as managed by one or more secondary feature servers 470, 472, 474. One such condition may include a win or lose game state that is used to increment or derive a winning percentage for a corresponding secondary feature. Another embodiment having a secondary feature tracking the number of credits won may require an additional secondary feature server 470, 472, 474 to be informed of the primary gaming result.

In step 715, when it is determined that at least one secondary feature is impacted, individual messages are generated and sent to the secondary feature servers 470, 472, 474 that are related to the impacted secondary features. For example, a play adjustment apparatus 450 coordinating the distributed slot machine tournament based on wager amount and winning percentage mentioned above, a message is now generated and sent to a secondary feature server (for example, server 470) indicating the outcome of the primary wagering game. Any number of secondary features and secondary feature servers 470, 472, 474 may be specified in response to the primary game response message, as long as a secondary feature is initialized and is being managed by one or more secondary feature servers 470, 472, 474 configured to receive such messages from the play adjustment apparatus 450.

In step 720, after any generation and transmission of messages that impact secondary features, a determination is made as to whether the received primary gaming response message (or more accurately, state of one or more primary gaming features) requires any resultant or consequential presentation of information or imagery on the secondary feature client 413.

In step 725, if presentation on the secondary feature client 413 display is determined to be required, one or more suitable messages are generated and sent to the secondary feature client 413 via the secondary feature client interface 453 to deliver appropriate information and cause such information display. For example, a secondary feature may be provided which displays extended animation when a particular symbol appears in a primary wagering game result, or the secondary feature simultaneously uses primary wagering game outcome data to perform or display a secondary game. Any messages which are appropriate for the secondary feature client 413 based upon the input message received from the primary gaming server 460 are generated and transmitted at this stage.

In step 730, after any appropriate display messages are generated and sent to the secondary feature client 413, a determination is made as to whether the received primary gaming result message requires information transfer to the primary gaming client 411. For example, the wagering game result may be required to be forwarded to the primary gaming client 411 for subsequent display to the player. Further, other types of response messages may be required for the primary gaming client 411, for example, responses having altered the winning pay out amount or in any other way changing the informational content of a given primary wagering game result message received from the primary gaming server 460.

In step 735, when the primary gaming client 411 is to be sent a primary wagering game result message, an appropriate response message is generated and sent to the primary gaming client 411 to report information comprising the result of the primary wagering game performed by the primary gaming server 460.

In some instances, this generated result message is fully distinct and different from the initial input result message received by the play adjustment apparatus 450. For example, if the play adjustment apparatus 450 is currently configured to perform secondary features that include contributions of winnings to specific accounts, and/or adjustment or addition of winning credit amounts, these generated result messages will differ from the originally received result message. Alternatively, in a play-while-away embodiment of the play adjustment apparatus 450, a single result message may be generated as a result of multiple primary game initiation messages, typically generated and delivered after the player has authenticated successfully to the play adjustment apparatus 450 and/or secondary feature servers 470, 472, 474. In an embodiment where the primary wagering game result is simply being tracked (for example, winning amount and/or winning percentages), the result message sent to the primary gaming client 411 may be forwarded in the same form as received by the play adjustment apparatus 450.

Once the detailed steps above are performed and completed, process 700 ends with step 799 upon termination.

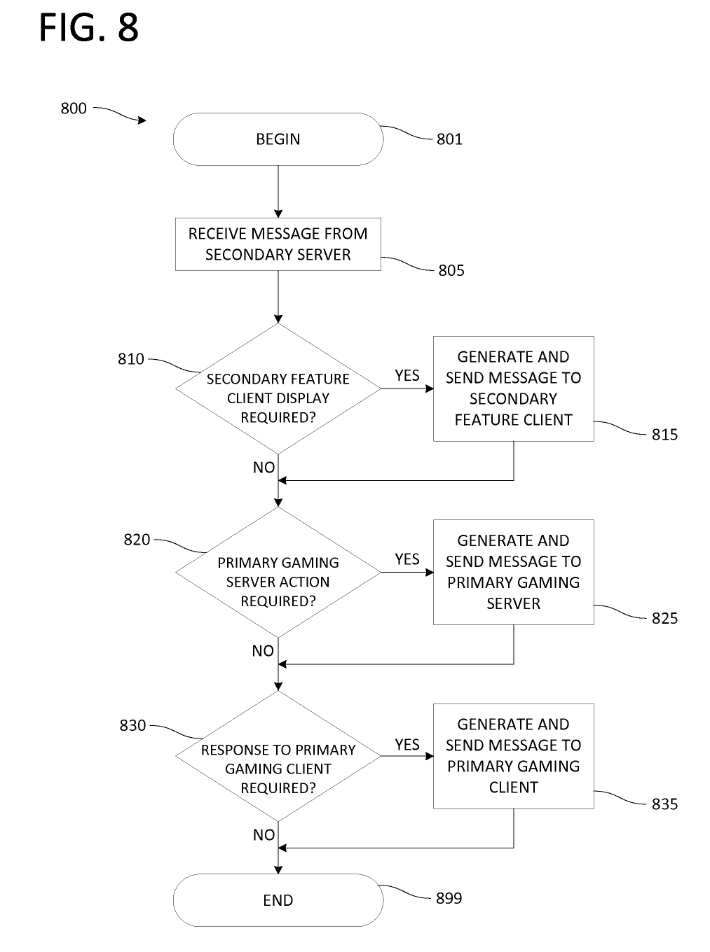

Referring to FIG. 8, an algorithmic process 800 is described which is performed when play adjustment apparatus 450 receives an input message from a secondary feature server 470, 472, 474 via the secondary feature server interface 459 in one embodiment. Process 800 begins with the initiation of the message reception process 801. This may be performed, for example, when the secondary feature server interface 459 is established, when the secondary feature servers 470, 472, 474 are initialized, or in response to a secondary feature client message received from the secondary feature client 413 to initiate a secondary feature.

In step 805, a message is received at the secondary feature server interface 459 from a secondary feature server 470, 472, 474.

In step 810, a determination is made as to whether the received message information requires presentation of information or imagery on the secondary feature client 413. For example, this may include a secondary feature result or other secondary feature event (or specified content for display) described within the message information.

In step 815, if presentation on the secondary feature client 413 display is required, one or more suitable messages are generated and sent to the secondary feature client 413 to cause such information display. For example, secondary feature presentation messages may include the result of one or more secondary features, an up-to-date scoreboard of ongoing or completed tournaments, presentation or imagery unrelated to the primary wagering game, presentation or imagery managed by the secondary features dependent upon the primary wagering game, casino promotion alerts, news or sport feeds, etc. The details of the secondary features and/or any included information for the display of the secondary features is now generated and sent to the secondary feature client 413 in a message for subsequent rendering.

In step 820, after any appropriate secondary feature client 413 display messages are generated and sent, a determination is made as to whether the secondary feature message requires any action or participation of the primary server 460.

In step 825, when action or participation of the primary server 460 is required, an appropriate message is generated and sent to the primary server 460 to conduct the primary wagering game. This may include performing one or more primary wagering games, where one or more secondary features may be subsequently affected, however, any secondary feature impact will likely be checked during a different transaction. The primary gaming server 460 conducts the suitable functions and actions as requested, including generation of a random number via a RNG, a determination of a resultant outcome, additional spins of the primary wagering game, etc.

Alternatively, in a play-while-away embodiment of the play adjustment apparatus 450, one or more primary gaming server messages may be generated at a specific or predetermined time. The generation of the one or more primary gaming server messages may be generated by the play adjustment apparatus 450 or by a specific secondary feature server 470, 472, 474. In yet another embodiment, the generated message may be a primary game reconfiguration message, causing the secondary feature to reconfigure the primary wagering game server 460 (e.g., the primary wagering game) in a specific way. Any initiation of the primary wagering game, caused by a corresponding secondary feature, will be triggered during this section of the process.

In step 830, after any appropriate display messages are generated and sent to the secondary feature client 413, and any action of the primary gaming server 460 is initiated (and potentially completed), a determination is made as to whether the received secondary feature (result) input message requires information transfer to the primary gaming client 411 for primary gaming client control, reconfiguration, or simply visual or audio presentation. For example, a modified primary wagering game result generated by a secondary feature may be required to be forwarded to the primary gaming client 411 for subsequent display to the player by the primary gaming client 411.

In step 835, when the primary gaming client 411 is to be sent a message as a result of a secondary feature result or presentation message, an appropriate response message is generated and sent to the primary gaming client 411 to report the intended information. This may include presentation of primary wagering games performed by the primary gaming server 460 on behalf of a secondary feature, report modified winnings altered by a secondary feature, etc., as specifically dictated by the message and the secondary feature as implemented.

Further, other types of response messages may be required for the primary gaming client 411, such as messages that alter the pay table, specify a presentation skin or theme, otherwise change the content of a given primary wagering game result message, or simply report the result of a secondary feature that may be presented by the primary gaming client 411. In an embodiment where the primary wagering game result is simply being tracked (for example, winning amount and/or winning percentages, only), no secondary feature result message is required to be sent to the primary gaming client 411, since the secondary feature results may not require any presentation on the primary gaming client 411. In general, if the information of the secondary feature server input message is solely confined to the secondary feature client 413, no primary gaming client 411 message will be required at this stage.

Once the detailed steps above are performed and completed, process 800 ends with step 899 upon termination.

It is also possible that a parallel process of determining whether a suitable number of responses are received, specifically in response to dispatching a number of requests or messages to fully complete a requested operation for any of the above processes. This type of sub-process may be similar or identical to the operation of the play adjustment apparatus 450 in steps 505 and 510, where messages are received to complete information gathering or reporting for a response generated as a result of multiple requests prior to further generation of outgoing messages or process completion. For example, during step 825, if a number of primary game server requests are made that result in only a single response to the player via the secondary feature, the primary gaming server 460 may be sent a number of messages and the play adjustment apparatus 450 may require a number of responses in return (each response causing play adjustment apparatus 450 to implement process 700 to modify and route messages). The play adjustment apparatus 450 is intelligent enough to perform such a function, essentially by running batches of requests and response collations as required by a specific secondary feature. In this way, it is possible for the play adjustment apparatus 450 to complete complex operations involving multiple primary servers 460 and secondary feature gaming servers 470, 472, 474, to implement secondary features having essentially infinite variety.

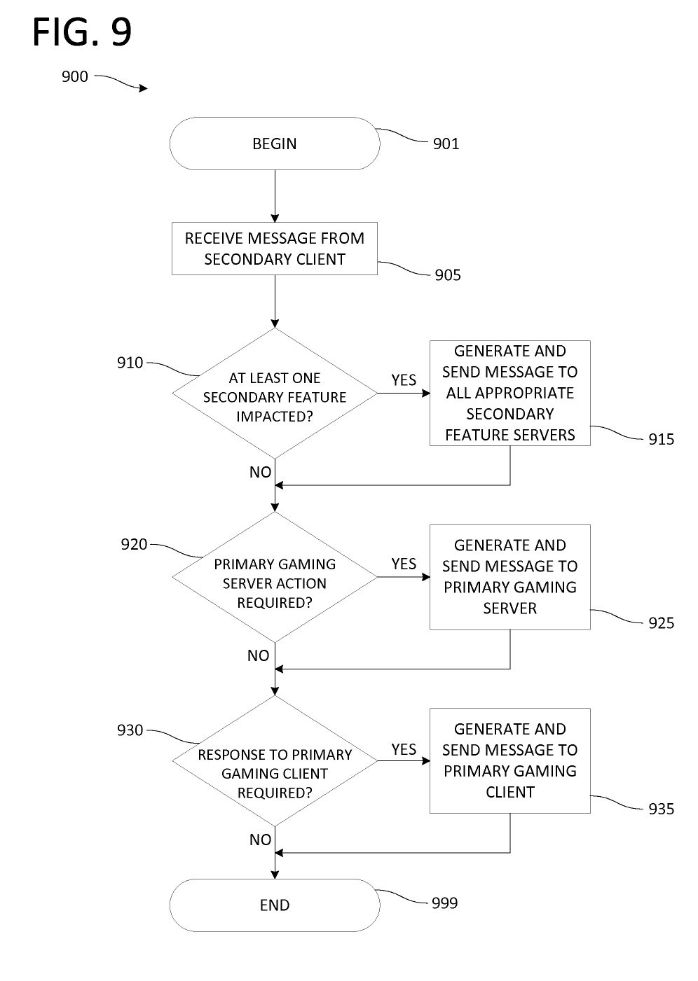

Referring to FIG. 9, an algorithmic process 900 is described which is performed when the play adjustment apparatus 450 receives an input message from the secondary feature client 413 via the secondary feature client interface 453 in one embodiment. Process 900 begins with the initiation of the message reception process 901. This may be performed, for example, when the secondary feature client interface 453 is established, when the secondary feature servers 470, 472, 474 are initialized, or in response to a secondary feature client message received from the secondary feature client 413 to initiate a secondary feature.

In step 905, a message is received at the secondary feature client interface 453 from the secondary feature client 413.

In step 910, a determination is made as to whether the message information (for example, a selection of a secondary feature, or a secondary feature client event described within the message information) impacts at least one secondary feature that is currently active.

In step 915, when it is determined that at least one secondary feature is impacted, individual messages are generated and sent to the secondary feature servers 470, 472, 474 that are related to the impacted secondary features. Any number of secondary features and secondary feature servers 470, 472, 474 may be specified in response to the secondary feature client message, as long as a secondary feature is initialized and is being managed by one or more secondary feature servers 470, 472, 474 configured to receive such messages from the play adjustment apparatus 450.

In step 920, after any appropriate secondary feature server messages are generated and sent, a determination is made as to whether the secondary feature client message requires any action or participation of the primary server 460.

In step 925, when action or participation of the primary server 460 is required, an appropriate message is generated and sent to the primary server 460 to conduct the primary wagering game. This may include performing one or more primary wagering games, for example, when the secondary feature client is used to initiate the primary wagering game. This in turn may also impact future or current secondary features. The play adjustment apparatus 450 is equipped to generate messages which are “native” to the primary gaming server 460, and the primary gaming server 460 interprets these messages as if they were issued by a legitimate primary gaming client 411. The primary gaming server 460 conducts the suitable functions and actions as requested, including generation of a random number via a RNG, a determination of a resultant outcome, additional spins of the primary wagering game, etc., as dictated by the secondary feature client message and the corresponding secondary features.

Alternatively, in a play-while-away embodiment of the play adjustment apparatus 450, this message may institute the play-while-away functionality, causing future primary gaming server messages to be generated at a specific or predetermined time at a specific or predetermined wager, either by the play adjustment apparatus 450 or by one or more of the secondary feature servers 470, 472, 474. In yet another embodiment, the generated message may be a user initiated reconfiguration message, causing the secondary feature to reconfigure the primary wagering game server 460 (e.g., the primary wagering game) in a specific way, for example, by substituting a pay table with a modified version or replacing the skin, game, or interface of the primary wagering game. Any initiation or modification of the primary wagering game that is caused by selections made at the secondary feature client will occur during this section of the process.

In step 930, after any secondary feature messages are generated and sent, and the primary gaming server 460 is suitably invoked, a determination is made as to whether the received secondary feature client message requires information transfer to the primary gaming client 411, itself, for example, to report and set configuration changes, or report primary game server 460 states or results. Embodiments where the secondary feature client is used to initiate the primary wagering game may also be invoked at this time using messages sent to the primary gaming server 460 via the primary gaming client 411.

In step 935, when the primary gaming client 411 is to be sent a secondary feature client message, an appropriate message is generated and sent to the primary gaming client 411 as specifically dictated by the message and the secondary feature and secondary feature client as implemented.

Once the detailed steps above are performed and completed, process 900 ends with step 999 upon termination.

The operation of the play adjustment apparatus 450 is generally invisible to the primary gaming client 411 and the primary gaming server 460. That is, the play adjustment apparatus 450 is suitable to be used between a legacy primary gaming client 411 and a legacy primary gaming server 460 that do not have any alteration of their programmatic behavior or any knowledge what-so-ever of the play adjustment apparatus 450. Further, the play adjustment apparatus 450 is capable of providing intermediary play adjustment for an unlimited number of secondary features that may all be performed independently, fully coordinated, or dependent upon related secondary feature outcomes and determinations as they change. The play adjustment apparatus 450 may also act as a unified intermediary device for a plurality of primary gaming servers 460 capable of being simultaneously performed, in series or in parallel, as a result of a single input at a primary gaming client machine 410.

As a result of the intermediary nature and operation of the play adjustment apparatus 450, the play adjustment apparatus 450 is required to have full knowledge of the messages that flow between all the components of the system. This includes the protocol(s), internal data, field values, etc., of the messages, whether proprietary or standardized. The play adjustment apparatus 450 may be configured and positioned to operate both physically and logically between a set of primary gaming client machines 410, a set of primary gaming servers 460, and a set of secondary features servers 470, 472, 474. The communicative techniques employed by the primary gaming client machines 410, primary gaming servers 460, and the secondary feature servers 470, 472, 474, are arbitrary, but must be understood and interpretable by the play adjustment apparatus 450.

The specific secondary features may encompass a huge variety of functions performed by the secondary feature servers 470, 472, 474, including but not limited to, a progressive controller, a tournament management controller, a promotional event controller, a play-while-away controller, and/or a game, skin, or content library enabling the play adjustment apparatus 450 to impart additional, potentially selective or directed presentation materials on the user interface of a primary gaming client machine 410 via a secondary feature client 413, and even (re)configure the primary gaming client machine 410 and primary gaming server 460.

Various embodiments have been mentioned above during the description of many of the functional elements above. In one embodiment, the play adjustment apparatus 450 intercepts communication between a legacy primary gaming server 460 performing a base wagering game and a secondary feature server 470, 472, 474 performing a secondary feature by dividing funds from submitted wagers and/or wins, either through manual manipulation and generation of messages as submitted or the specification or selection of new, modified pay tables. The wagers and outcome for each wagering game may be easily leveraged for additional secondary features, including tournaments, either through straight-forward variable incrementing or corresponding tournament points mapping and generation.

Another embodiment includes the selective routing of messages coming from primary gaming clients 460 to secondary feature servers 470, 472, 474 programmed to play a modified version of the primary wagering base game.

Another embodiment leverages the play adjustment apparatus 450 to make a series of wagers of one or more specific primary wagering games during a specified time period. The play adjustment apparatus 450 may operate as a timed proxy of the primary gaming client 411 or the secondary feature client 413. Alternatively, the play adjustment apparatus 450 can be made highly intelligent, providing functionality that includes triggering wagering game initiation messages in response to specific conditions or a fluid definition that uses any type of relationship to ascertain time and amount for a particular wager. In most cases, the play adjustment apparatus 450 is equipped to collate the results from a set of primary wagering games into a single response that can be reported to a player, account, or server, upon proper authentication. For example, when a particular player reconnects, the play adjustment apparatus 450 intercepts the reconnection request and reports results for any or all games or events played on behalf of the player.

Another embodiment utilizes the play adjustment apparatus 450 to commit some of an original wager amount and/or piggy-back on responses to modify winning results by altering the responses to fund alternative accounts, e.g., donating to a specific charity or committing funds for proportionate entries in a particular upcoming contest or event. In this embodiment, the original primary wagering game messages may be modified at the play adjustment apparatus 450, separate from or in addition to, primary gaming server result messages being modified at the play adjustment apparatus 450.

Another embodiment includes the utilization of a secondary module that implements the secondary feature client (or an additional secondary feature client) to display additional content or data, potentially as part of the primary base game. Naturally, any or all of the secondary feature client processes may be used to display information to the player, but the alteration of the messages passing between primary gaming client machines 410 and primary gaming servers 460 enable a much richer platform for altering primary base game play and presentation.

Another embodiment includes the addition of bonus games, bonus symbols, and/or game play triggered events from the primary base game that are performed by one or more secondary servers by passing messages via the play adjustment apparatus 450. For example, in response to five consecutive winning spins of a video slot machine of a primary wagering game, a secondary feature may perform a special bonus game running against a promotional credit pool of available funds that are awarded as bonus awards.

Another embodiment includes the supplementing of primary game results with additional funds that are deducted from a dedicated promotional account. For example, a casino may offer higher payouts for wins that occur on primary games using a promotional skin. The play adjustment apparatus 450 intercepts the messages flowing between the primary gaming client 411 and the primary gaming server 460 and may alter the amount of winnings based on the state of one or more primary game conditions.

In another embodiment, the play adjustment apparatus 450 includes a single communication channel connecting with the primary gaming client 411 and the secondary feature client 413. In this embodiment, the primary gaming client interface 451 and the secondary feature client interface 453 are merged together into a single unified interface for the primary gaming client machine 410, while maintaining the logical separation of the primary gaming client interface 451 and the secondary feature client interface 453. While the primary gaming client interface 451 and the secondary feature client interface 453 are generally regarded as a physical connection component (e.g., plug(s), jack(s), connector(s), etc.), an underlying software component is generally also implemented in combination (e.g., device driver, communication protocol definition/stack, etc.). The combination of hardware and functionality obviates the requirement for the primary gaming client 411, the secondary feature client 413, and the play adjustment apparatus 450 to know the precise details of the physical interfaces being used for connection. It is therefore possible to utilize a single connective medium to connect the primary gaming client machine 410 directly to the play adjustment apparatus 450 for all communications, without departing from the spirit and scope of the invention. Alternatively, a separate dedicated secondary channel connecting the primary gaming client machine 410 directly to the play adjustment apparatus 450 may be utilized, used solely for any secondary feature displays and information not part of a dedicated primary gaming client and primary gaming server channel. Many variations of these embodiments can occur when the play adjustment apparatus 450 is coupled or integrated with various components of the system, for example, embedded or integrated into the primary gaming client machine 410, a PUI module at an arbitrary place in the system (not shown), secondary devices including mobile or community display devices, or coupled to or integrated with one or more of the primary gaming server 460 and the secondary feature servers 470. 472, 474.

As described, the intermediary play adjustment apparatus 450 bi-directionally communicates with the primary gaming client machine 410, a primary gaming server, and one or more secondary feature servers 470, 472, 474 and is capable of analyzing incoming messages to determine the contents of the message. In response, the intermediary play adjustment apparatus 450 is equipped to dynamically generate messages to any of these system components to effect any combination of functional behavior. Thus, the intermediary play adjustment apparatus 450 is able to modify functional behavior of the primary wagering game and any number of associated secondary features together in a unified fashion.

Initialization messages issued from a primary gaming client 411 may be analyzed and altered by the intermediary play adjustment apparatus 450 to modify active pay tables, return modified pay tables, redirect communications to an alternate server, effect simultaneous communication with one or more secondary servers, etc., without the primary gaming client 411 ever being aware of the presence of any secondary features or redirected communications. The intermediary play adjustment apparatus 450 may also actively track client activity from a variety of primary clients, enabling a secondary feature to maintain a list of clients, players, or statistics, by invisibly scanning all communication traffic.

Likewise, in response to a primary gaming client 411 initiating a wagering game (e.g., “spin reels” button press), the intermediary play adjustment apparatus 450 may intercept the initiation message to split a specified wager among multiple gaming or feature servers, sending a reduced wager amount to the primary gaming server 460 and a secondary message to a secondary feature server 470, 472, 474 regarding the second wager portion.

When the intermediary play adjustment apparatus 450 receives an input message from the primary gaming server 460, the input message will typically be analyzed to determine how the primary wagering game outcome affects the secondary feature. Primary wagering game outcomes may be analyzed for wins or win amounts to accumulate tournament points (that will not typically require modification of the input message prior to retransmission), splitting winning payouts to fund a secondary feature pool (that will require modification of the input message prior to retransmission to the primary client), etc. Depending on the particular secondary feature currently being performed, the intermediary play adjustment apparatus 450 may result modification or tabulation for deduction of winning payouts along with reflection of wins and/or win amounts after deduction, accumulated tournament points based on wins or payout amounts, counting a number of spins and/or payout percentages, amount of winnings or wager deducted for secondary feature, etc. The primary gaming client 411 receives the modified data as if it was received directly from primary gaming server 460.

When the intermediary play adjustment apparatus 450 receives an input message from a secondary feature server 470, 472, 474 that causes a message to be generated and sent to the primary gaming server 460, the primary gaming server 460 may respond with modified game configuration information (e.g., substituted or modified pay table to reflect any effects of the secondary feature), and be configured as such for current or future primary wagering games.

When the intermediary play adjustment apparatus 450 receives an input message from a secondary feature server 470, 472, 474 that causes a message to be generated and sent to the secondary feature client 413, the secondary feature client 413 may display this information including pay out amounts, primary gaming and/or secondary feature results (e.g., tournament results or rankings), an indication of the secondary feature impact or modification of the primary wagering base game and/or role of the primary gaming server 460 (reflecting the alteration of the primary wagering game), or information restricted solely to a secondary feature that does not relate to the primary wagering game at all. If there is a need for the play adjustment apparatus 450 to parse, translate, and/or format the message or informational content for display by the secondary feature client 413, the play adjustment apparatus 450 is highly diverse and is fully capable of controlling informational content and presentation to the player in a variety of ways.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. An intermediary play adjustment apparatus bi-directionally communicating with a gaming client performing presentation of a primary wagering game, a primary gaming server performing one or more functions related to the primary wagering game, and a secondary feature server performing a secondary feature, the intermediary play adjustment apparatus comprising:
a primary gaming client interface coupled to the gaming client;
a primary gaming server interface coupled to the primary gaming server;
a secondary feature server interface coupled to the secondary feature server;
one or more central processing units; and
one or more memory devices storing instructions that, when executed by the one or more central processing units, cause the intermediary play adjustment apparatus to:
receive, via the primary gaming client interface, the primary gaming server interface, or the secondary feature server interface, an input message;
determine whether the input message corresponds to a game event that impacts the secondary feature;
in response to determining that the input message corresponds to a game event that impacts the secondary feature, generate and send, via the secondary feature server interface, a corresponding second feature message to the secondary feature server;
determine whether the input message corresponds to a game event that triggers an action by the primary gaming server;
in response to determining that the input message corresponds to a game event that triggers an action by the primary gaming server, generate and send, via the primary gaming server interface, a corresponding primary gaming message to the primary gaming server;
determine whether the input message corresponds to a game event that requires display on the gaming client; and
in response to determining that the input message corresponds to a game event that requires display on the gaming client, generate and send, via the primary client interface, a corresponding primary display message to the gaming client.

2. The intermediary play adjustment apparatus of claim 1, wherein the intermediary play adjustment apparatus further comprises a secondary feature client interface coupled to a secondary feature client, the secondary feature client performing presentation of the secondary feature on the gaming client, wherein the instructions further cause the intermediary play adjustment apparatus to:
determine whether the input message corresponds to a game event that requires display on the secondary feature client; and
in response to determining that the input message corresponds to a game event that requires display on the secondary feature client, generate and send, via the secondary feature client interface, a corresponding secondary feature display message to the gaming client.

3. The intermediary play adjustment apparatus of claim 2, wherein the instructions further cause the intermediary play adjustment apparatus to:
determine whether the input message initiates a play-while-away secondary feature; and
in response to the input message initiating a play-while-away secondary feature, generate and send a plurality of primary messages, via the appropriate primary gaming server interface or the secondary feature server interface, to the appropriate primary gaming server or secondary feature server, and generate and send, via the secondary feature client interface, a secondary response message containing information derived from at least one of a plurality of corresponding primary responses to the secondary feature client.

4. The intermediary play adjustment apparatus of claim 3, wherein the plurality of primary messages and the secondary response message are received via a secondary play-while-away feature server interface prior to generation.

5. The intermediary play adjustment apparatus of claim 1, wherein all functions of the intermediary play adjustment apparatus are unbeknownst to the gaming client running on a legacy gaming electronic game machine and the primary gaming server running on a legacy primary wagering game server.

6. The intermediary play adjustment apparatus of claim 1, wherein the intermediary play adjustment apparatus includes a plurality of additional secondary feature server interfaces, each additional secondary feature server interface communicating with an additional corresponding secondary feature server.

7. The intermediary play adjustment apparatus of claim 1, wherein a primary game wager specified in the input message is modified to become a modified primary game wager, and the secondary message includes a secondary feature wager derived from the primary game wager.

8. The intermediary play adjustment apparatus of claim 1, wherein the secondary feature server is a progressive controller, a tournament management controller, or a promotional event controller.

9. An intermediary play adjustment apparatus bi-directionally communicating with a gaming client performing presentation of a primary wagering game, a secondary feature client performing presentation of a secondary feature, a primary gaming server performing one or more functions related to the primary wagering game, and a secondary feature server performing the secondary feature, the intermediary play adjustment apparatus comprising:
a primary gaming client interface coupled to the gaming client;
a primary gaming server interface coupled to the primary gaming server;
a secondary feature client interface coupled to the secondary feature client;
a secondary feature server interface coupled to the secondary feature server;
one or more central processing units; and
one or more memory devices storing instructions that, when executed by the one or more central processing units, cause the intermediary play adjustment apparatus to:
receive, via the primary gaming client interface, the primary gaming server interface, or the secondary feature server interface, an input message;
determine whether the input message corresponds to a game event that impacts the secondary feature;
in response to determining that the input message corresponds to a game event that impacts the secondary feature, generate and send, via the secondary feature server interface, a corresponding second feature message to the secondary feature server;
determine whether the input message corresponds to a game event that triggers an action by the primary gaming server;
in response to determining that the input message corresponds to a game event that triggers an action by the primary gaming server, generate and send, via the primary gaming server interface, a corresponding primary gaming message to the primary gaming server;
determine whether the input message corresponds to a game event that requires display on the secondary feature client; and
in response to determining that the input message corresponds to a game event that requires display on the secondary feature client, generate and send, via the secondary feature client interface, a corresponding secondary feature display message to the gaming client.

10. The intermediary play adjustment apparatus of claim 9, wherein the instructions further cause the intermediary play adjustment apparatus to:
determine whether the input message initiates a play-while-away secondary feature; and
in response to the input message initiating a play-while-away secondary feature, generate and send a plurality of primary messages, via the appropriate primary gaming server interface or the secondary feature server interface, to the appropriate primary gaming server or secondary feature server, and generate and send, via the secondary feature client interface, a secondary response message containing information derived from at least one of a plurality of corresponding primary responses to the secondary feature client.

11. The intermediary play adjustment apparatus of claim 10, wherein the plurality of primary messages and the secondary response message are received via a secondary play-while-away feature server interface prior to generation.

12. The intermediary play adjustment apparatus of claim 9, wherein all functions of the intermediary play adjustment apparatus are unbeknownst to the gaming client running on a legacy gaming electronic game machine and the primary gaming server running on a legacy primary wagering game server.

13. The intermediary play adjustment apparatus of claim 9, wherein the intermediary play adjustment apparatus includes a plurality of additional secondary feature server interfaces, each additional secondary feature server interface communicating with an additional corresponding secondary feature server.

14. The intermediary play adjustment apparatus of claim 9, wherein a primary game wager specified in the input message is modified to become a modified primary game wager, and the secondary message includes a secondary feature wager derived from the primary game wager.

15. The intermediary play adjustment apparatus of claim 9, wherein the secondary feature server is a progressive controller, a tournament management controller, or a promotional event controller.

16. An intermediary play adjustment apparatus bi-directionally communicating with a gaming client performing presentation of a wagering gaming feature, and a feature server performing one or more functions related to the wagering gaming feature, the intermediary play adjustment apparatus comprising:
a gaming client interface coupled to the gaming client;
a feature server interface coupled to the feature server;
one or more central processing units; and
one or more memory devices storing instructions that, when executed by the one or more central processing units, cause the intermediary play adjustment apparatus to:
receive, via the gaming client interface or the feature server interface, an input message;
determine whether the input message corresponds to the wagering gaming feature;
in response to determining that the input message corresponds to the wagering gaming feature and the input message is received via the gaming client interface, generate and send, via the feature server interface, a modified feature message to the feature server derived from the input message; and
in response to determining that the input message corresponds to the wagering gaming feature and the input message is received via the feature server interface, generate and send, via the gaming client interface, a modified feature response message to the gaming client derived from the input message.

17. The intermediary play adjustment apparatus of claim 16, wherein the instructions further cause the intermediary play adjustment apparatus to:
determine whether the input message initiates a play-while-away secondary feature; and
in response to the input message initiating a play-while-away secondary feature, generate and send a plurality of primary messages, via the feature server interface, to the feature server, and generate and send, via the gaming client interface, a secondary response message containing information derived from at least one of a plurality of corresponding primary responses to the gaming client.

18. The intermediary play adjustment apparatus of claim 16, wherein all functions of the intermediary play adjustment apparatus are unbeknownst to the gaming client running on a legacy gaming electronic game machine and the feature server running on a legacy wagering game server.

19. The intermediary play adjustment apparatus of claim 16, wherein the modified feature message indicates a modified wager that is different than the wager indicated in the input message.

20. The intermediary play adjustment apparatus of claim 16, wherein the modified feature response message indicates a modified payout as part of the modified response result that is different than an unmodified payout specified in the response result indicated in the input message.
